(19) United States
(12) Patent Application Publication
(10) Pub. No.: US 2011/0130096 A1
(43) Pub. Date: Jun. 2, 2011

(54) OPERATION CONTROL AND DATA PROCESSING IN AN ELECTRONIC PEN

(76) Inventor: Anders Dunkars, Falun (SE)

(21) Appl. No.: 12/306,666

(22) PCT Filed: Jun. 20, 2007
(86) PCT No.: PCT/SE07/00603

§ 371 Date: Sep. 30, 2009

Related U.S. Application Data
(60) Provisional application No. 60/817,404, filed on Jun. 30, 2006.

(30) Foreign Application Priority Data
Jun. 28, 2006 (SE) 0601405-4
Mar. 16, 2007 (SE) 0700675-2

(51) Int. Cl. H04W 88/02; G06K 9/22; G06K 9/46

(52) U.S. Cl. 455/41.2; 382/314; 382/190

(57) ABSTRACT

An electronic pen is configured for transmitting coordinate data to an external terminal. The pen includes an image component (200) configured to generate a digital image of a region on a writing surface. Further, the pen includes a communication component (202) comprising an image analysis module (202b) configured to receive image data representative of said digital image and to transform the image data into coordinate data, and a transmitter module (202c) configured to transmit the coordinate data to the external terminal. The communication component (202) may be a standard communication circuit with spare processing capacity, in which the image analysis module (202b) is implemented by image analysis software loaded into a working memory and executed by a processor of the communication component (202).

### CROSS-REFERENCE TO RELATED APPLICATIONS

The present application claims the benefit of Swedish patent application No. 0601405-4, filed on Jun. 28, 2006; U.S. provisional patent application No. 60/817,404, filed on Jun. 30, 2006; and Swedish patent application No. 0700675-2, filed on Mar. 16, 2007, all of which are hereby incorporated by reference.

### TECHNICAL FIELD

The present invention generally relates to an electronic pen for transmitting coordinate data to an external terminal, a system comprising an electronic pen and an external terminal, and a method for transmitting coordinate data from an electronic pen to an external terminal. The invention also relates to a method for connecting an electronic pen to an external terminal, and an electronic pen comprising electronic circuitry operable in different power modes.

### BACKGROUND OF THE INVENTION

Electronic pens for transforming handwritten information into digital information have been introduced in the market during recent years. For instance, the Swedish company Anoto has developed such electronic pens.

The Anoto technology is based on an electronic pen comprising a small built-in camera, a built-in processor and a memory, combined with a paper with a dot pattern.

When writing with the pen, the camera continuously captures images of the dot pattern on the paper. Concurrently, the built-in processor determines, from the dot pattern in the images, the momentary position of the pen tip.

An interactive pen has been developed by Leapfrog Enterprises based on the Anoto technology. Such a pen is described in US 2006/0033725, and is marketed as a pentop computer under the brand name “FLY”. This pen comprises application software which, based on a sequence of pen positions determined by the processor, for example may determine which character or word that has been written. When knowing the word, the application software may translate the word to another language, whereupon the translation of the word may be spoken by the pen via an integrated loudspeaker.

However, in order to make these applications possible, a powerful processor and/or a large memory may be required in the pen, and in some cases also additional hardware, such as a loudspeaker. These requirements may make the pen less cost efficient, less power efficient and large.

US2002/0046887 discloses another type of pen which has an area sensor for capturing images of a coding pattern embedded in a transparent plate which is superposed on an LCD. The pen further contains a signal processing circuit for binarizing the images, a computation control circuit for calculating coordinates from the binarized images, and a transmitting circuit for outputting the calculated coordinates. Application software on an external device may be operated based on the coordinates from the pen, and feedback may be provided on the LCD. Although the pen is strictly dedicated to outputting coordinates, its cost of manufacturing may still be undesirably high, i.a., due to the need for customized circuits to capture, binarize and decode the images.

### SUMMARY OF THE INVENTION

In view of the above, an objective of the invention is to solve or at least reduce the problems discussed above.

A first aspect of the invention is an electronic pen for transmitting coordinate data to an external terminal, the pen comprising an image component configured to generate a digital image of a region of a writing surface, and a communication component comprising an image analysis module configured to receive image data representative of said digital image and to transform said image data into coordinate data, and a transmitter module configured to transmit said coordinate data to said external terminal.

The first aspect of the invention may serve to reduce the number of electronic components in the pen, thereby providing for reductions in size, cost and power consumption.

In one embodiment, the communication component is implemented on a standard communication circuit with spare processing capacity, suitably by loading dedicated image analysis software into a working memory of the communication component and operating a processor in the communication component to execute the thus-loaded software. This may further improve the cost-effectiveness of the pen.

In another embodiment, software for controlling the operation of the pen is executed by a processor in the image component or the communication component, thereby reducing the need for a separate pen-control processor.

The writing surface can be a paper, or another suitable type of product, provided with a pattern from which the coordinate data can be derived. In one embodiment, the pattern is a coding pattern that codes absolute positions. Such a coding pattern may comprise code symbols including, but not limited to, circles, squares, triangles, dots, etc. Additionally, such code symbols may be filled or non-filled. Moreover, the coding pattern may comprise code symbols having different size, shape, color, etc.

In one embodiment, the electronic pen further includes a pre-processor module configured to extract the image data from the digital image. The pre-processor module may be included in the image component or the communication component, or may be a separate component.

The image data may be extracted from the digital image to be indicative of code symbols represented in the digital image. Thus, the image data may be a compact representation of the original digital image, e.g. in the form of a cut-out of an original digital image, a binarized version of at least part of such an original image, a listing of relevant coding features of the code symbols (such as location, size, shape, color, etc.), or a listing of coding values of the coding symbols.

A second aspect of the invention is a system for transmission of coordinate data, comprising an electronic pen according to the first aspect, and an external terminal configured for reception of coordinate data transmitted from the electronic pen.

A third aspect of the invention is a method for transmitting coordinate data from an electronic pen comprising an image component and a communication component to an external terminal, the method comprising generating, in said image component, a digital image representing a region of a writing surface; receiving, in said communication component, image data representative of said digital image; transforming the received image data into coordinate data in said communication component; and transmitting said coordinate data from said communication component to said external terminal.

A fourth aspect of the invention is a method for connecting an electronic pen to an external terminal, the method comprising initiating a set-up procedure for connecting the electronic pen to a pre-chosen external terminal; and if a pen tip of said electronic pen is applied onto a surface during said set-up procedure, enabling selection among non-pre-chosen external terminals, and initiating a procedure for connecting to a selected terminal among said non-pre-chosen external terminals.

A fifth aspect of the invention is an electronic pen comprising electronic circuitry operable in a high-power mode, a medium-power mode and a low-power mode; a sensor for detecting whether or not a tip of the electronic pen is applied onto a writing surface; and a power management system coupled to the sensor and configured to operate the electronic circuitry: in the high-power mode whenever the tip is in contact with the writing surface, in the medium-power mode whenever the tip is brought out of contact with the writing surface, and in the low-power mode when the tip has been out of contact with the writing surface for more than a predetermined time period.

Other objectives, features and advantages of the present invention will appear from the following detailed description, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention, will be better understood through the following illustrative and non-limiting detailed description of exemplifying embodiments of the present invention, with reference to the appended drawings.

FIG. 1 is a schematic illustration of an overall principle of an electronic pen system including an electronic pen and an external terminal.

FIGS. 2A-2C illustrate three different hardware combinations forming processing circuitry of an electronic pen, each including a communication component capable of both determining and transmitting coordinate data.

FIG. 3 is a schematic flow chart of a method for transmitting coordinate data from an electronic pen to the external terminal.

FIG. 4 is a schematic illustration of an electronic pen with a proximity sensor coupled to the pen tip.

FIG. 5 is a schematic illustration of an electronic pen with a proximity sensor utilizing echolocation.

FIG. 6 is a schematic flow chart illustrating an exemplifying method of determining coordinate data from an image of a dot pattern.

FIG. 7 is a schematic flow chart illustrating the first step in FIG. 6 in further detail.

FIG. 8 is a block diagram illustrating an electronic pen system in further detail.

FIG. 9 is a schematic block diagram illustrating the operation of an access-granting module of an electronic pen.

FIG. 10 is a schematic illustration of a hardware realization of an electronic pen.

FIG. 11 is a schematic illustration of an image component in an electronic pen.

FIG. 12 is a schematic illustration of an overall function of a power management system in an electronic pen.

FIG. 13 is a schematic flow chart illustrating a set-up procedure for an electronic pen system.

### DETAILED DESCRIPTION OF EXEMPLIFYING EMBODIMENTS

### Introduction to Electronic Pen System

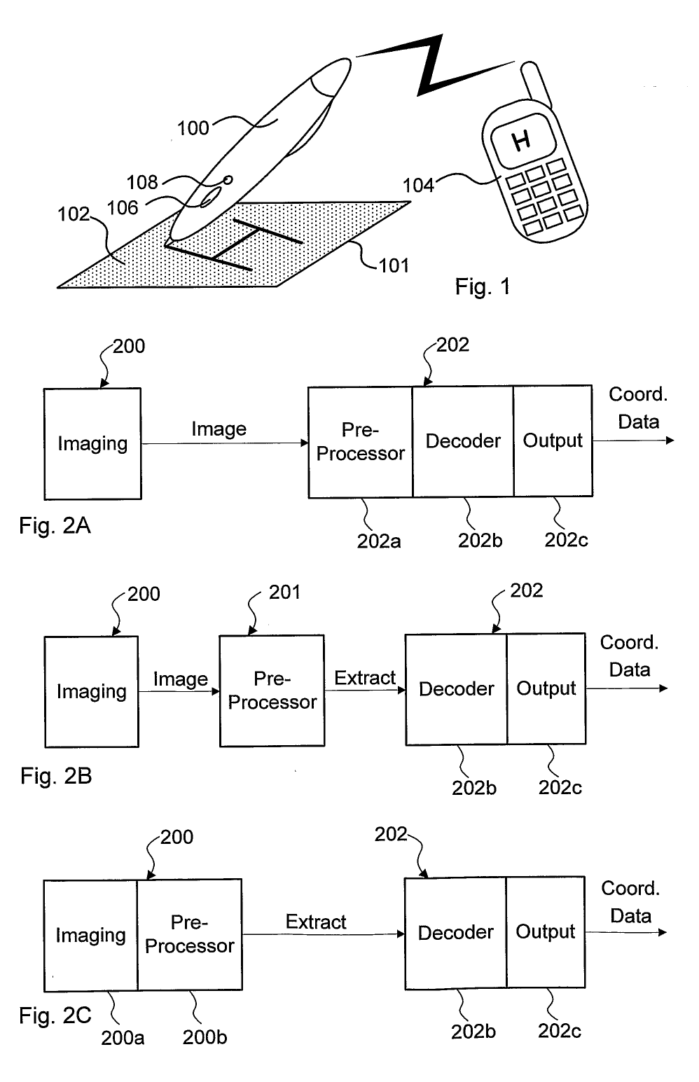

FIG. 1 shows the overall principle of an electronic pen system comprising an electronic pen 100, a paper 101 with a coding pattern 102 provided on its surface, and an external terminal 104.

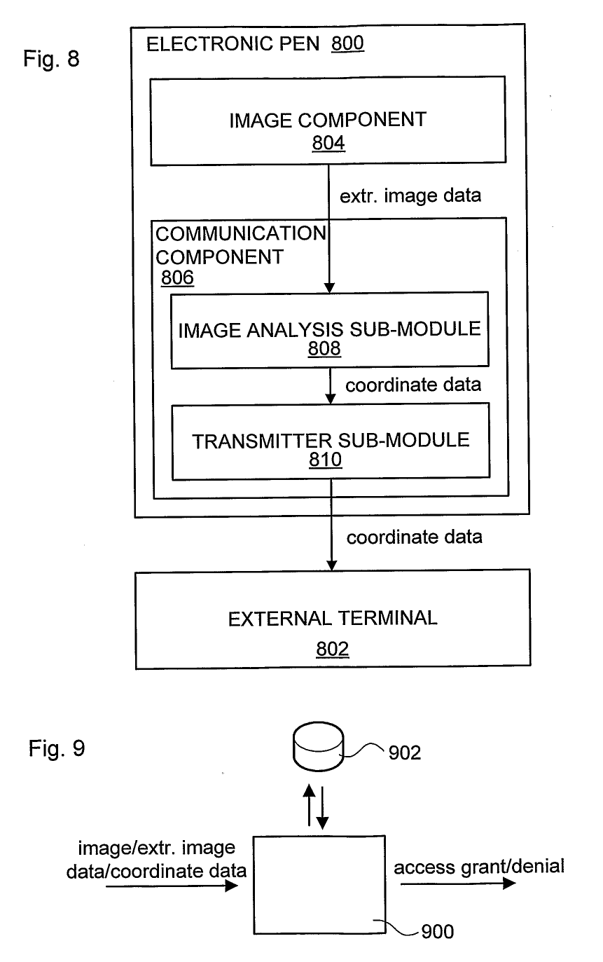

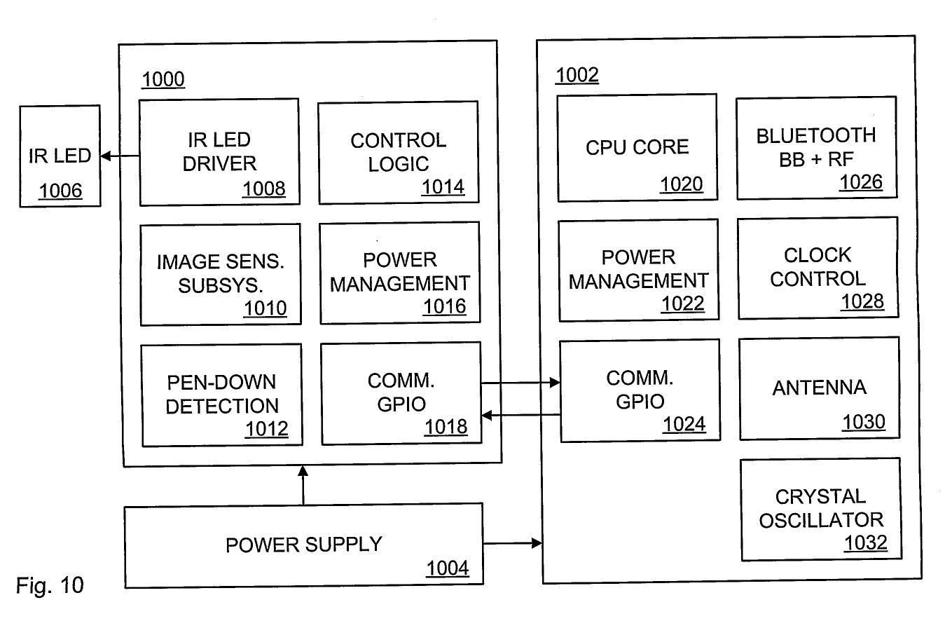

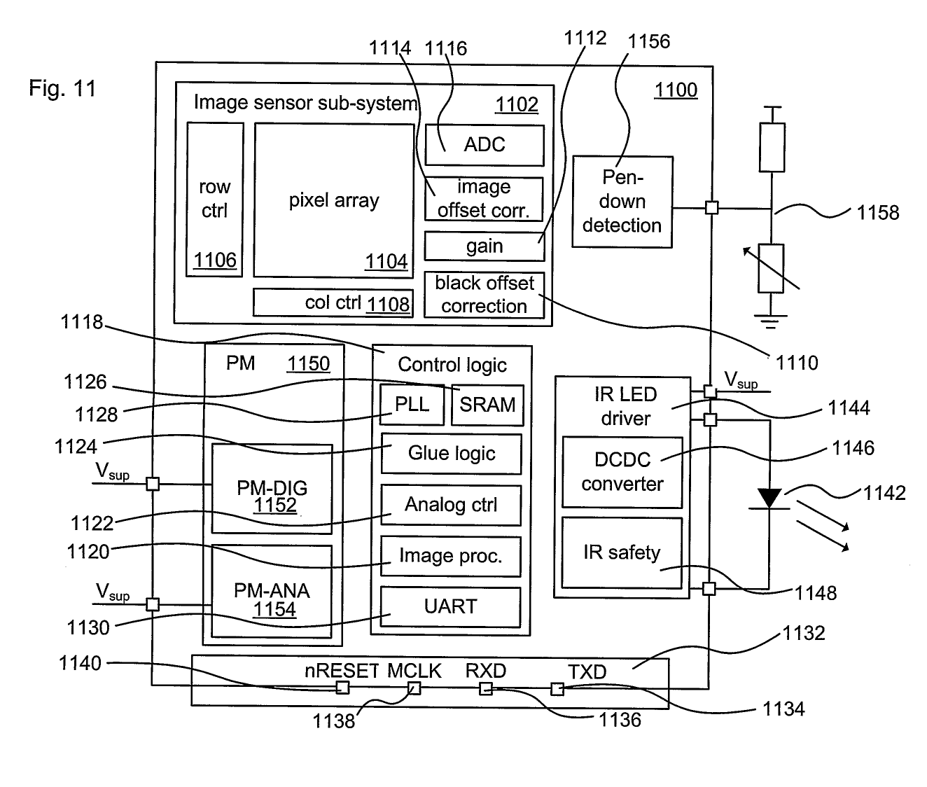

A message or other piece of information, in this case the letter “H”, is written with the electronic pen 100 on the paper 101. Thus, the surface of the paper 101 with the coding pattern 102 acts as a writing surface for a user of the pen 100. An image of a region of the surface of the paper 101 nearby the pen tip is captured by a camera in the pen 100. The camera may include image-forming optics and an image circuit for generating a electronic image, and possibly also for pre-processing the electronic image. An embodiment of such an image circuit or component will be described in more detail later on with reference to FIGS. 8, 10 and 11. Based on the image, and the coding pattern it represents, coordinate data for the momentary location of the pen tip may determined by a communication circuit or component in the pen 100. An embodiment of such a communication component will be described in more detail later on with reference to FIGS. 8 and 10.

The coordinate data may then be output, by the communication component, for receipt by an external terminal 104 for further processing. This further processing can, for instance, be to determine which word that has been written and possibly also a translation of this word, and, if a loudspeaker is available at the external terminal, to speak out the translation.

In other words, the pen 100 may determine coordinate data and the external terminal 104 may use the coordinate data in at least one application program, in this example implementing a translation service.

If the coordinate data is output from the pen according to a standard communication protocol, such as the HID (Human Interface Device) protocol, the fact that an electronic pen is involved implies no special considerations when developing application programs for the external terminal.

Additionally, the pen 100 can comprise an input device, such as a button 106, and an output device, such as an indicator LED 108, for interaction with the user. The button 106 may for instance be an ON/OFF button, or a multifunction button of common electromechanical or touch-sensitive type.

The external terminal 104 may favorably be a mobile phone, since it is mobile by nature and has a powerful processor, high memory capacity, display, loudspeaker etc., and is most often carried by the user. However, other types of mobile or stationary devices may be used as external terminal, for example a PDA (Personal Digital Assistant), laptop computer, PC, game console, home entertainment system, set top box, TV, etc.

An effect of determining the coordinate data in the pen and executing the application program(s) in the external terminal is that the pen can contain a less powerful processor and a smaller memory, which implies that the pen can be cost-efficient and small.

Another effect is that the type of application program, and its implementation, is not restricted to the hardware of the pen 100, which may have an MMI (Man Machine Interface) with limited functionality, and computing hardware with limited performance.

### Processing Circuitry in Electronic Pen

As indicated above, the pen may comprise an image component and a communication component. The communication component may be configured, through dedicated hardware and/or software, to output coordinate data in one or more predetermined formats/protocols. According to one aspect of the present invention, this communication component also comprises dedicated hardware and/or software to determine the coordinate data. Thereby, the number of separate electronic components in the pen may be reduced. This may lower the cost of the pen, and possibly also lower its power consumption.

In one embodiment, the communication component is a standard communication circuit, in which the determination of coordinate data is effected by loading dedicated software into a working memory of the communication circuit and causing a processor in the communication circuit to execute the thus-loaded software. Thus, spare processing power of a standard communication circuit may used to implement the coordinate determination. The use of a standardized circuit may further improve the cost-effectiveness of the pen.

In yet another embodiment, a processor in the image component or the communication component controls the overall operation of the pen, including start-up, operation and shutdown of its electronic circuitry. This may be achieved by the component loading dedicated system control software into an internal working memory (RAM) from an internal or external storage memory. The absence of a dedicated processor for controlling the pen allows for low cost and low power consumption.

FIGS. 2A-2C illustrates three different combinations of separate hardware components for implementing the functionality of the pen in FIG. 1.

In FIG. 2A, the pen comprises an image component 200 and a communication component 202. The image component 200 generates images of the writing surface. The communication component 202 comprises a pre-processor part 202a which processes the images to extract data, a decoding part 202b which processes the extracted data to determine the coordinate data, and a communication part 202c which outputs the coordinate data.

In FIG. 2B, the pen comprises an image component 200, an image pre-processor component 201 and a communication component 202. The image component 200 generates images of the writing surface. The image pre-processor component 201 processes the images to extract data. The communication component 202 comprises a decoder part 202b which processes the extracted data to determine the coordinate data, and a data output part 202c which outputs the coordinate data.

In FIG. 2C, the pen comprises an image component 200 and a communication component 202. The image component 200 comprises an image-generation part 200a which generates images of the writing surface, and a pre-processor part 200b which processes the images to extract data. The communication component 202 comprises a decoder part 202b which processes the extracted data to determine the coordinate data, and a data output part 202c which outputs the coordinate data.

The operation, control, functionality and structure of an embodiment of the electronic pen will now be described in further detail, based on the basic hardware combination illustrated in FIG. 2C. However, it should be realized that the details of the following embodiment are readily applicable to the alternative hardware combinations in FIGS. 2A-2B as well.

Transmitting Coordinate Data from Electronic Pen to External Terminal

The communication component 202 may be configured for wireless output of coordinate data, e.g. by using the Bluetooth™ or IrDA standards or any WLAN technique, or for wire-based output, e.g. by using the USB standard or any other suitable standard for serial or parallel data communication.

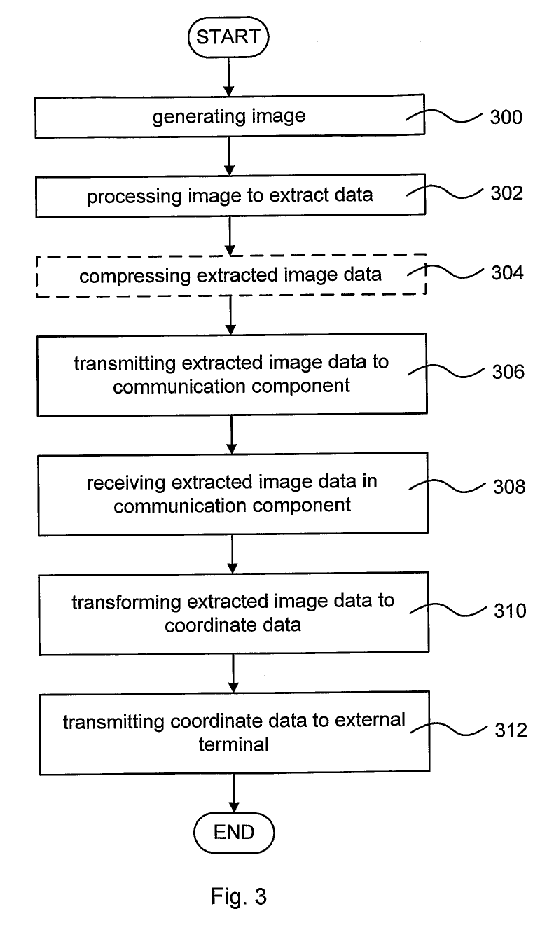

FIG. 3 illustrates a method in an electronic pen for outputting coordinate data.

In step 300, an image is generated, by operating the image-generation part 200a of the image component 200 in the electronic pen.

In step 302, the image is processed by operating the pre-processor part 200b of the image component 200. This step can comprise identifying code symbols in the image of the writing surface and forming extracted image data based upon these code symbols. Thus, the extracted image data may be extracted from the image to be indicative of code symbols therein.

Optionally, in step 304, the extracted image data can be compressed using any known lossless or lossy data compression algorithm.

In step 306, the extracted image data is transmitted to the communication component 202.

In step 308, the extracted image data is received by the communication component 202.

In step 310, the extracted image data is transformed to coordinate data, by operating the decoder part 202b of the communication component 202. This step can comprise transforming the extracted image data into a predetermined perspective, and then determining the coordinate data that corresponds to the code symbols represented in the extracted image data.

In step 312, the coordinate data is output, by operating the data output part 202c of the communication component 202, for receipt by the external terminal.

Suitably, the image component 200 and the communication component 202 are controlled to operate whenever the pen is applied to the writing surface, so that coordinate data is output to represent the movement of the pen on the surface (pen strokes).

In a variant, step 312 is postponed until the pen is lifted from the writing surface, so that coordinate packages (e.g. pen strokes) are output from the pen instead of individual positions. As will be further described below, the pen may also be configured to buffer the coordinate data in an internal memory, e.g. if the communication component 202 is unable to establish contact with the external terminal.

### The Paper

The coding pattern 102 on the paper 101 may comprise a number of dots arranged in such a way that the pen 100 can determine an absolute position based on an image of a pattern portion. If the pen 100 has a pen tip, the pen may capture images of this dot pattern near the pen tip and derive therefrom the positions encoded at each momentary location of the pen tip on the paper 101.

In the exemplifying embodiment, the dots are arranged in rows and columns. Moreover, each dot is slightly shifted either right, left, up or down from an associated grid point in an invisible regular grid formation on the paper 101. In this way each dot represents one of four different values, i.e. 2 bits of data. In a commercial implementation, each group of 6×6 adjacent dots encodes a unique position, nominally allowing for encoding of 2⁷² different positions. The spacing between two grid points in the same row or column is 0.3 mm, which means that a very large area with uniquely encoded pen positions is achievable.

In the exemplifying embodiment, the images captured by the camera in the pen 100 are digital images, in grayscale or color, in which the dots appear as dark areas against a luminant background.

Also, in the exemplifying embodiment, the dot pattern 102 on the paper 101 is a subset of a large abstract position-coding pattern, which is subdivided into page units. Examples of such abstract patterns are given in U.S. Pat. No. 6,570,104; U.S. Pat. No. 6,663,008 and U.S. Pat. No. 6,667,695, which are herewith incorporated by reference. The page units may be individually addressable in a hierarchy of page unit groups, involving segments, shelves, books, and page units (the latter also being referred to as “pattern pages”). Suitably, all pattern pages have the same format within one level of the above pattern hierarchy. For example, some shelves may consist of pattern pages in A4 format, while other shelves consist of pattern pages in A5 format. The location of a certain pattern page in the abstract pattern can be noted as a page address of the form: segment.shelf.book.page, for instance 99.5000.1.1500, more or less like an IP address. For reasons of processing efficiency, the internal representation of the page address may be different, for example given as an integer of a predetermined length, e.g. 64 bits.

In one example, each segment may consist of more than 26,000,000 pattern pages, each with a size of about 50×50 cm². At least one such segment may be divided into 5,175 shelves, each consisting of 2 books with 2,517 pages each.

Each pattern page is thus a unique subset of the abstract pattern and encodes a set of unique absolute positions, typically X,Y coordinates. Each such absolute position may be represented as a global position in the coordinate system of the overall pattern, or as logical position, i.e. a page address and a local position in a given coordinate system within the pattern page.

Depending on implementation, the electronic pen may record its motion on the writing surface (paper 101) as either a sequence of global positions or a sequence of logical positions.

Although the dot pattern described above has many advantages, the present invention may be used in connection with various other absolute position-coding patterns based on other types of code symbols, e.g. as described in U.S. Pat. No. 5,852,434; U.S. Pat. No. 5,661,506; U.S. Pat. No. 6,330,976 and WO 2006/006922. In fact, any type of pattern may be used if only the relative movement of the electronic pen is to be determined.

### Pen-Down Detection

The pen may have a proximity sensor for indicating that the pen is close to, or in contact with, a writing surface (“pen down”). To reduce power consumption, electronic circuitry in the pen may be selectively activated only when a wake-up signal, originating from the proximity sensor, indicates that the pen is sufficiently close to the writing surface.

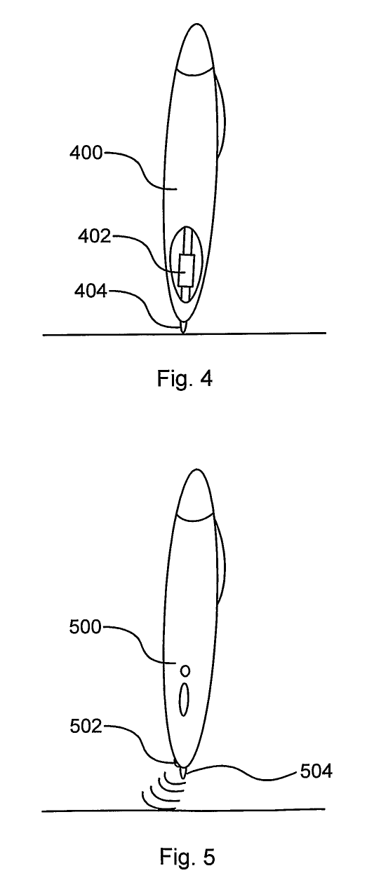

FIG. 4 shows an embodiment 400 of the electronic pen with a tip sensor 402 coupled to or associated with a tip or nib 404 of the pen.

Another type of proximity sensor is configured to generate the wake-up signal based on radiation detected by a radiation sensor in the pen.

In one embodiment, the pen contains a radiation source which is intermittently or continuously activated to emit radiation. Whenever the pen is brought sufficiently close to a writing surface, the radiation sensor detects a sufficient amount of radiation reflected off the writing surface and issues a wake-up signal for relevant parts of the electronic circuitry of the pen. The radiation sensor may be aforesaid image component or a dedicated sensor.

In a more advanced embodiment, the proximity sensor utilizes image analysis. In brief, such a proximity sensor may receive an image from an image sensor in the pen, e.g. aforesaid image component or a separate dedicated sensor, and analyze the image for identification of a predetermined coding pattern. Upon identification of the coding pattern in the image, the proximity sensor may issue the wake-up signal. Alternatively or additionally, the proximity sensor may calculate the distance and/or the direction of movement between the pen tip and the writing surface from the image and use the distance/direction in determining when to transmit the wake-up signal. By using distance/direction information, the wake-up signal may be trans-miffed even before the pen has come into contact with the writing surface, thereby improving the pen-down response time. Such a proximity sensor may or may not be implemented as part of the image component (200 in FIGS. 2A-2C). To reduce power consumption, it is conceivable to operate the image sensor at a reduced frequency during pen up, when the images are used for proximity detection only, and at the nominal frame rate during pen down, when the images may be used for coordinate determination. A further power saving measure could be to activate only a part of the radiation-sensing area of the image component during pen up.

An alternative is to combine a tip sensor with the use of radiation detection and/or image analysis.

FIG. 5 shows yet another embodiment of a proximity sensor 502 in an electronic pen 500. The sensor 502 infers the distance and/or direction of movement between the pen and the writing surface through echolocation, i.e. by analyzing the travel time of a signal which originates from the pen and is reflected by the writing surface. The signal may be sound waves, e.g. ultrasound, or electromagnetic radiation, e.g. radio waves, infrared radiation, ultraviolet radiation, etc.

Still an alternative is to combine the echolocation sensor with a tip sensor and, optionally, with image analysis.

### Transforming Images to Coordinate Data

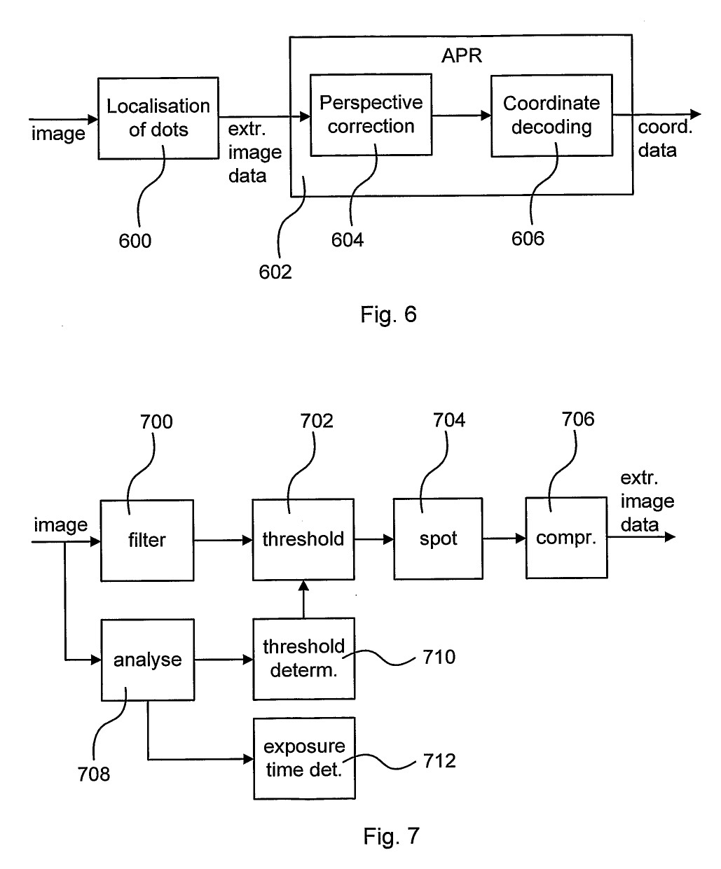

FIG. 6 illustrates general steps of transforming a digital image of the above-discussed dot pattern to coordinate data. These steps are suitably performed in image component 200 and communication component 202 (FIG. 2C). The digital image is captured by the image-generation part 200a of the image component 200.

In a first step 600, after having received the image, the pre-processor part 200b processes the image to identify or locate dots therein.

After having located the dots, the pre-processor part 200b forms a so-called dot list to indicate the location of the dots in the image. The location of a dot may be given as a pixel number or an x,y location in a reference coordinate system of the image-generation part 200a. Thus, the dot list is a compact representation of the originating image.

Thereafter, the dot list is transferred from the image component 200 to the communication component 202. Then, a second step 602, denoted APR, is performed by the decoder part 202b. Step 602 may be divided into two sub-steps: a perspective correction step 604 and a coordinate data decoding step 606.

The perspective correction step 604 may include transforming the dot locations in the dot list into a predetermined perspective. Thus, regardless of the angle of the electronic pen to the writing surface (paper 101) at the moment when the image was captured, the corresponding dot list will be transformed into the predetermined perspective. The predetermined perspective can for instance be a null-perspective, in which all perspective distortions have been removed, or a othogonal perspective, in which the dot list (i.e. the dot locations) looks as if it was retrieved by looking along the normal direction of the writing surface.

Then, in the second sub-step 606, coordinate data is determined based on the dot list output from the perspective correction step 604.

Different embodiments of identifying and correcting for perspective and determining coordinate data are found in U.S. Pat. No. 6,548,768; U.S. Pat. No. 6,667,695; U.S. Pat. No. 6,674,427; U.S. Pat. No. 6,732,927; U.S. Pat. No. 6,929,183; U.S. Pat. No. 7,050,653; WO 03/038741; WO 2004/097723 and WO 2005/059819, which are incorporated herein by reference.

In the disclosed embodiment, the APR functionality of steps 604 and 606 is implemented as software/firmware executed by a processor in a CPU core 1020 of the communication component (see FIG. 10). The software/firmware may be stored in internal ROM of the CPU core 1020, or in an external ROM, from any of which it is copied to internal RAM at start-up. The software/firmware implementation is advantageous since little, if any, hardware redesign is required when a commercially available data transmission circuit, e.g. a Bluetooth™ circuit, is to be used as a base for the communication component. Alternatively, however, the APR functionality may be implemented by customized hardware which may be integrated with a customized or commercially available data transmission circuit.

In a variant to the above, the perspective correction step 604 is performed by the pre-processor part 200b of the image component 200 when it generates the dot list.

In FIG. 7, an embodiment of the localization of dots (step 600 in FIG. 6), performed in the pre-processor part 200b, is illustrated in more detail.

In step 700, the input image may be filtered to remove essentially all differences in background luminosity in the image. To this end, each pixel value may be filtered via a two-dimensional convolution of a linear zero-sum filter operating on a neighborhood of a current pixel, thereby producing peaks for small dark regions on an otherwise smooth background level close to zero.

Thereafter, in step 702, the image may be binarized by mapping the image against a corresponding threshold surface and setting pixel values to either 1 or 0 depending on their relation to a co-located threshold value. An arbitrary threshold surface may be used, or a single value may be used for the complete image. However, it is also possible to use a threshold surface adaptively calculated in a threshold determination step 710.

In step 704, the dots in the image are spotted by identifying connected dark areas (connected components) in the binarized image, e.g. using a 4- or 8-connectivity neighborhood. The locations of the spotted dots are then calculated as the center of gravity of each connected component. Optionally, certain connected components are ignored in view of predetermined lower and/or upper area limits. The resulting dot locations are then arranged in a dot list, optionally together with an area measure for each dot. The dot list may be in any suitable format, e.g. in plain text or as encoded in any base.

Thereafter, in step 706, the dot list may be compressed, in order to further reduce the amount of information.

In a parallel step 708, the image may be analyzed, to thereby generate image statistics to be used in the above-mentioned threshold determination step 710 and/or an exposure time determination step 712.

In step 710, the statistics from the analysis step 708 may be used to estimate the threshold surface. For example, based on the contrast at certain sample points in the image, a threshold surface may be fitted to these sample points under a predetermined bending constraint for the surface. Alternative embodiments are disclosed in WO 03/001450 and WO 03/044740, which are incorporated herein by reference.

Moreover, based on the statistics from the analysis step 708, an exposure time is determined in a step 712. This exposure time may be used to control the activation of a shutter in the camera and/or an illumination element, such as an LED, laser diode or lamp in the pen. Embodiments for such determination are disclosed in WO 03/030082, which is incorporated herein by reference.

The output of steps 700-706 thus constitutes a pre-processed version of the received image.

### Schematic Illustration of Electronic Pen System

In FIG. 8, a schematic illustration of the electronic pen system is shown.

The electronic pen system according to the disclosed embodiment comprises an electronic pen 800, such as any of the pens 100, 400 or 500 described above, and an external terminal 802.

The pen 800 comprises two main processing components: an image component 804 (corresponding to component 200 of FIG. 2C) and a communication component 806 (corresponding to component 202 of FIG. 2C).

The image component 804 may comprise an image sensor, a processor and memory for generating images and processing the images for extraction of data. As exemplified above, this processing may comprise locating dots in a captured image, forming a dot list of the located dots and transmitting the dot list to the communication component 806.

The image component 804 can be an electronic device dedicated for generating an image and for extracting relevant coding pattern information (dot list) from the image. An example of such a dedicated electronic device is illustrated in FIG. 11.

Schematically, the communication component 806 comprises an image analysis sub-module 808 (corresponding to the decoder part 202b of FIG. 2C) and a transmitter sub-module 810 (corresponding to the output part 202c of FIG. 2C).

The communication component 806 can be an electronic transmitter device with spare processing capacity, such as a Bluetooth™ chip, wherein the spare processing capacity is utilized for transforming the dot list into coordinate data, for example according to the APR model of FIG. 6.

The dot list is received by the communication component. Thereafter, the dot list is transformed into coordinate data according to the above-described steps 604-606. After having transformed the dot list into coordinate data, the coordinate data is transmitted to the external terminal 802.

The coordinate data may be given in global positions, or if the pen stores data on the subdivision of the abstract pattern, as logical positions.

The coordinate data is received by an application program in the terminal 802. Such an application program can be a drawing service that displays the pen strokes written by the pen 800 on the paper, or any other service utilizing coordinate data. Non-limiting examples include a word processing application with character recognition functionality for interpreting characters or symbols from handwritten input, or a translator service.

The coordinate data can be streamed, i.e. transmitted in near real time from the pen 800 to the terminal 802. Alternatively, the coordinate data may be buffered in a memory of the pen 800 for subsequent transmission to the terminal 804 as a stream of individual x,y coordinates or as one or more data packets. Each such data packet may contain a set of coordinate data, such as one or more pen strokes. Buffered data can be transmitted to the external terminal 802 upon a user request, for example generated by a button on the pen being pressed or by the pen being placed with its camera capturing an image of a dedicated part of the dot pattern (suitably indicated to the user by a visible send icon on the paper). Alternatively, buffered data can be transmitted automatically after a timeout, or caused by a pen-up of the pen.

In yet another embodiment, the pen is configured to stream the coordinate data, but buffers the data if it fails to make contact with the external terminal via the communication component 806. The coordinate data is suitably buffered in a non-volatile memory unit, to be transmitted at a later time when contact is established with the terminal. When contact is established, the communication component 806 may transmit the buffered data to the terminal, optionally with an indicator that the data has been buffered. In one embodiment, the buffered data has priority, so that buffered data is always transmitted before any newly generated data. In an alternative embodiment, newly generated data has priority over buffered data. In either variant, transmitting the buffered data may involve sending a message to the external terminal indicating that buffered data is available. The message may also indicate the origin of the buffered data, e.g. the page addresses of the buffered data. The application program in the terminal may then, optionally under the control of a user, choose whether or not to instruct the pen to transmit such buffered data.

The coordinate data may be output in any standard or proprietary format. In one specific embodiment, the communication component 806 generates output data in the form of events. Typically, one event is generated for each image captured by the image component 804. These events may include: Coord (including a determined position, and optionally an associated pressure value), PenDown (indicating start of a pen stroke), and PenUp (indicating end of a pen stroke). Further conceivable events include: CoordFailed (indicating failure in position determination), NoCode (indicating inability to detect pattern), and Locked (indicating that the pen is operated on non-allowable pattern, see below). Each such event may comprise a sequence number that allows a processor, in the pen or in the receiving terminal, to recreate the order of events. Thus, the sequence number may be a time-stamp given in the absolute time frame of a clock in the pen. Alternatively, the events following upon each PenDown are given unique incrementing sequence numbers. For example, each PenDown may be associated with sequence number 0, and the following events may be associated with sequence numbers 1, 2, 3, etc. Thereby, a processor is able to identify “lost positions” in the stream of events, even without use of a CoordFailed event. Alternatively or additionally, each sequence number may indicate the time elapsed since the latest Pen-Down.

The communication component 806 is suitably configured to output data according to a standard communication protocol. One such protocol frequently used to transmit coordinate data is the HID (Human Interface Device) protocol. By using such a standard protocol, no special considerations are needed even though the coordinate data is generated by an electronic pen rather than an ordinary computer peripheral.

In one embodiment, shown in FIG. 9, the pen further includes an access-granting module 900, realized in hardware and/or software, which directly or indirectly operates to selectively block coordinate data from being output by the pen. The access-granting sub-module 900 may use the images, the extracted image data or the coordinate data as input. The sub-module 900 may map this input, or data derived therefrom, against a data structure 902 identifying allowable pattern, and output an access signal indicating either access grant or access denial. The pen may selectively allow processing and/or data output based on the access signal. For example, the image component may be blocked from generating a digital image or from extracting image data therefrom, or the communication component may be blocked from transforming the image data into coordinate data or from transmitting the coordinate data.

In one example, the data structure 902 identifies allowable pattern pages, i.e. those pattern pages from which the pen is allowed to output coordinate data. These allowable pattern pages could be defined as a region in global positions, a set of individual pattern pages, a segment, a shelf, a book, etc. Coordinate data falling outside these allowable pattern pages will not be output by the pen. Thereby, the functionality can be differentiated between different electronic pens, or types of such pens, even though they all may be capable of reading and decoding the same abstract pattern. In an alternative embodiment, the data structure 902 may instead identify non-allowable pattern.

The module 900 may be part of the image component and/or the communication component or it may be implemented as a separate component.

It should be realized that the access-granting sub-module 900 is universally applicable to electronic pens, i.e. not only the type of electronic pens described explicitly herein.

### Hardware Realization of Electronic Pen

In FIG. 10, a hardware realization of the electronic pen is diagrammatically illustrated.

It should be noted that parts not contributing to the core of the present invention are left out, or are being described briefly, in order not to obscure the features of the present invention.

In this hardware realization, there are three main components; an image component 1000 (corresponding to components 200, 804), a communication component 1002 (corresponding to components 202, 806) and a power supply 1004.

Outside these components an IR LED 1006 for illuminating the region close to the pen tip is present.

The image component 1000 comprises an IR LED driver 1008, an image sensor sub-system 1010 with a pixel array, a pen-down detection (PDD) module 1012, a control logic module 1014, a power management (PM) module 1016 and a communication/GPIO (General Purpose Input/Output) module 1018.

The communication component 1002 comprises a CPU core module 1020, a power management (PM) module 1022, a communication/GPIO module 1024, a Bluetooth BB and RF (Baseband and RF Frequency) module 1026, a clock control module 1028, an antenna 1030 and a crystal oscillator 1032. The crystal oscillator 1032 provides a basic clock signal which is used by the clock control module 1028 to generate clock signals for other modules, for example a CPU clock signal for module 1020, a Bluetooth clock signal for module 1026, as well as an external clock signal for the image component 1000.

In the disclosed embodiment, the overall pen operation is controlled by system control software/firmware which is executed by a processor in the CPU core 1020. The software/firmware may be stored in internal ROM of the CPU core 1020, or in a separate memory unit (ROM, EPROM, EEPROM, Flash, etc) from which it is copied to internal RAM at start-up. Such system control includes controlling the start-up, continuous operation and shutdown of the image and communication components, as well as selectively activating the pen's MMI. The system control may also implement further pen functions, such as a power management function, a procedure for buffering coordinate data, and a procedure for setting up a communication link between the pen and the external terminal.

### Image Component in Detail

In FIG. 11, a hardware realization 1100 of the image component 1000 is shown in further detail.

Again, it should be noted that parts not contributing to the core of the present invention are left out, or are being described briefly, in order not to obscure the features of the present invention.

The general purpose of the image component is, in this exemplifying embodiment, to generate images that each represents a region of a writing surface, suitably near the pen tip of the pen, and then after image processing transmit the resulting data to the communication component (not shown in FIG. 11).

In order to fulfill this purpose a number of sub-modules and sub-systems have been developed.

### Image Sensor Sub-System

Firstly, an image sensor sub-system 1102 is utilized for generating digital images.

The image sensor sub-system 1102 comprises a pixel array 1104 on which light impinges and is transformed to analog electronic signals. For controlling the pixel array 1104, a row control module 1106 and a column control module 1108 are used.

Thereafter, the analog electronic signals are transmitted to a black offset correction module 1110. In this module, the black offset of the analog electronic signals may be adjusted in accordance with a reference black offset.

Thereafter, the analog electronic signals are transmitted to a gain module 1112 in which the signals, or parts of the signals, may be amplified.

Next, the analog electronic signals are transmitted to an image offset correction module 1114. In this module the signals may be transformed in such a way that the image, given by the analog electronic signals, is aligned in accordance with a reference alignment.

Finally, the analog electronic signals are converted to digital signals, i.e. a digital image, by an ADC (Analog-Digital Converter) 1116.

### Control Logic

Secondly, the digital image is transmitted to a control logic module 1118.

More specifically, the image is transmitted to an image processing module 1120, in which a dot list is created based on the image, as described above with reference to FIGS. 6-7.

The control logic module 1118 also comprises digital components for controlling the operation of the image component 1100. One sub-module, an analog control module 1122, controls the analog parts of the image component 1100, such as the image sensor sub-system 1102. Another sub-module, a glue logic module 1124, controls other operations, such as memory handling etc.

Further, the control logic module 1118 comprises a memory 1126, e.g. an SRAM, a PLL (Phased Locked Loop) 1128 and an UART (Universal Asynchronous Receiver-Transmitter) 1130.

In the illustrated embodiment, the image component 1100 lacks an internal clock, but is instead operated based on an external clock signal supplied on an MCLK pin 1138 of communication interface 1132. This clock signal may be generated by the clock control module 1028 in the communication component 1002 (FIG. 10). In a variant (not shown), the image component 1100 may have an internal clock.

### Communication Interface

Thirdly, when the dot list has been created in the control logic module 1118, the dot list is transmitted to the communication component 1002, which is a separate hardware component comprised within the pen. The transmission is made via a TXD pin 1134 in the communication interface 1132. The communication interface 1132 further comprises an RXD pin 1136 for reception of signals, the MCLK pin 1138, and an nRESET pin 1140 for resetting the image component 1100.

### Controlling Light Conditions

In order to improve the quality of the captured image, the writing surface is in this example illuminated by an IR LED (Infrared Light Emitting Diode) 1142 (cfr 1006 in FIG. 10). The IR LED 1142 is located at the front end of the electronic pen, and is coupled by wires to the image component 1100.

By having an IR LED 1142 in the pen, light conditions (such as wavelength, intensity, pulse length etc.) can be controlled. This means that the other parts of the image component 1100 can be tuned according to the light conditions which, in turn, may improve the quality of the captured image.

Another aspect of having the IR LED 1142 is that dependence on ambient light is reduced. Still an aspect is that disturbance from ambient light is reduced. For instance, if the IR LED 1142 is pulsed at a predetermined frequency with a predetermined wavelength, the image component can reduce the effect of the ambient light by only considering the images acquired at a corresponding frequency and at a corresponding wavelength.

Since infrared light is not visible to the human eye, the user will not be aware of the IR LED 1142.

The IR LED 1142 is driven by an IR LED driver 1144. The IR LED driver 1144 is divided into two sub-modules; a DCDC converter 1146 and an IR safety module 1148.

The DCDC converter 1146 ensures that a stable and suitable voltage, e.g. 2.7 V, is applied over the IR LED 1142 which, in turn, means that the light characteristics of the IR LED 1142, when activated, is stable.

One way of ensuring a stable voltage is to have a first capacitor, often referred to as a “barrel”, connected in parallel with the IR LED 1142 for taking care of voltage surplus, i.e. when the voltage exceeds the intended level, and a second capacitor, often referred to as a “bucket”, in a separate circuit for holding a spare voltage which is used for compensating a voltage deficit, i.e. when the voltage falls below the intended level.

The IR safety module 1148 is a logic module which makes sure that the power consumption of the IR LED 1142 is not abnormal, in particular to avoid excessive power output. If such abnormal power consumption is detected, the IR LED 1142 is switched off. In this way, it is ensured that the output luminosity of the IR LED 1142 never reaches a level that is harmful to the human eye.

### Power Management of Image Component

In order to improve the power efficiency of the electronic pen, a power management (PM) module 1150 (also seen as 1016 in FIG. 10) may be introduced in the image component.

The tasks of such a PM module 1150 could include to identify a current suitable power state of the image component and/or to set the image component in this state by activating those parts of the component that are needed at the identified power state.

The PM module 1150 may be further divided into a power management module for digital components (PM-DIG) 1152 and a power management module for analog components (PM-ANA) 1154.

In order to set the current power state of the image component, as well as the electronic pen as a whole, a pen-down detection (PDD) module 1156 (also seen as 1012 in FIG. 10) may be utilized. The PDD module 1156 may be configured to receive a signal from a proximity sensor 1158 which may be of the type described with respect to FIGS. 4-5. The output signal of the sensor 1158 may or may not vary according to the application pressure of the pen tip to the writing surface. The PDD module 1156 may generate, based on the proximity sensor output signal, a PDD signal indicating whether the pen is put down on the writing surface (pen down) or not (pen up). Suitably, the PDD module 1156 is a passive component that does not need to be powered to generate the PDD signal. One such embodiment is disclosed in WO 03/069547 which is incorporated herein by reference. In a variant, the PDD module is incorporated as part of the communication component, or is a separate component.

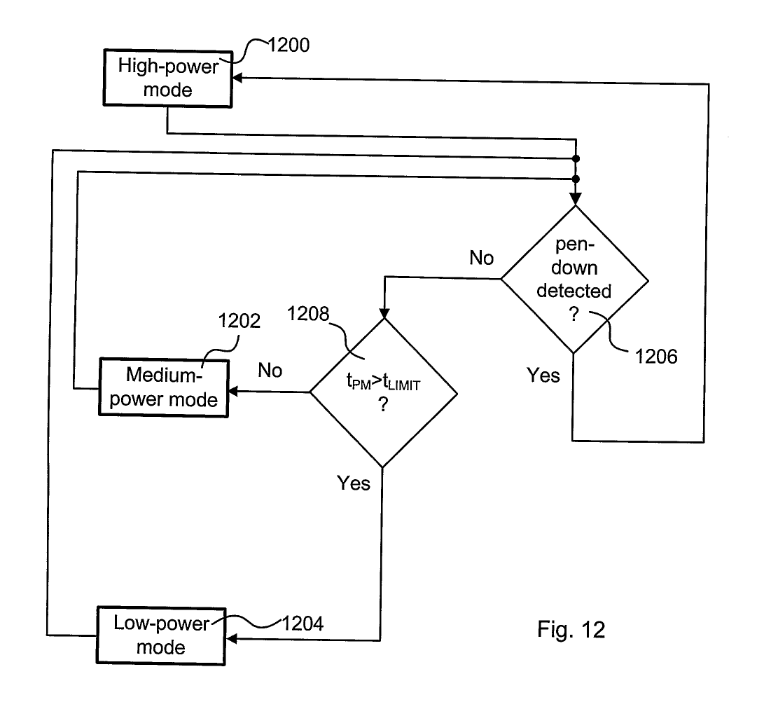

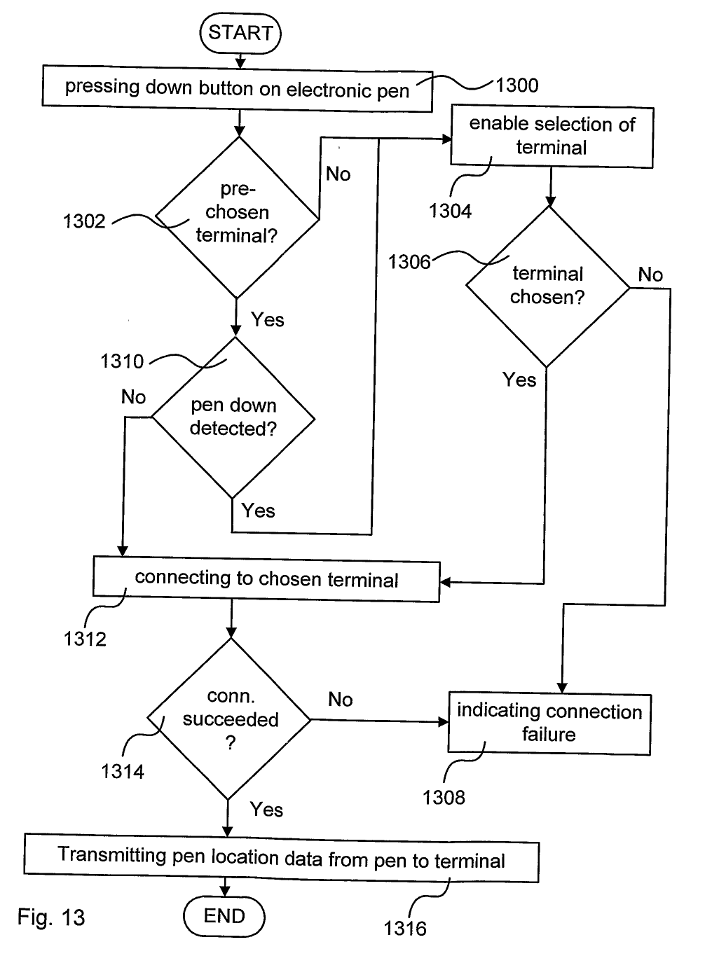

The PDD signal may be received by the PM module 1150 of the image component 1100, and may also transmitted to the PM module 1022 of the communication component 1002 via the TXD pin 1134 of the communication interface 1132 in order to set the power state of the communication component correctly, as will be further explained below with reference to FIG. 12.

If the PDD signal indicates that the pen has been brought into contact with the writing surface (pen down), the image component (and the pen) is set in a high power mode, e.g. by the PM-ANA 1154 causing the control logic module 1118 to synchronously activate the IR LED driver 1144 to illuminate the writing surface close to the pen tip, and the image sensor sub-system 1102 to generate digital images. Typically, such activation is repeated at a fixed or variable frequency (frame rate) in the range of 50-100 Hz during pen down.

If the PDD signal indicates that the pen has been lifted from the writing surface (pen up), the image component (and the pen) leaves the high-power mode, by the PM-ANA 1154 causing the control logic module 1118 to deactivate the image sensor sub-system 1102 and the IR LED driver 1144.

In a variant (not shown), the power state of the image component is instead controlled by the communication component. For example, the communication component may set the power state of the image component by writing dedicated commands in dedicated registers of the image component, and/or by generating dedicated control signals on the input pins of the image component (e.g. the RXD and/or MCLK pins). Again, the power state may be set as a function of the output signal of a PDD module, which may be part of the image component (as in FIGS. 10-11), part of the communication component, or a separate component.

The following discussion presumes that the power states of the image component can be divided into two general states: an active state in which the image component is fully powered up, i.e. both analog and digital elements are powered up, and a passive state in which at least the image-generating parts are deactivated, i.e. the analog elements are not powered up.

### Power Management of Electronic Pen

FIG. 12 illustrates an embodiment of an overall power management function for an electronic pen.

Although the image component and the communication component each may attain different power states, every such state or combination of states is related to one of three general power modes of the electronic pen: a high-power mode 1200, a medium-power mode 1202 and a low-power mode 1204.

Generally, the high-power mode 1200 is entered in situations involving many processor operations, typically when the user writes with the pen. According to the description above, such a situation may be indicated by the PDD module 1156.

In one embodiment, the high-power mode can be divided into two sub-modes reflecting different power states of the communication component, referred to as HPS1 and HPS2, wherein HPS1 is the highest power state and the HPS2 is the second highest power state. In both of these high-power sub-modes, the image component is in its active state.

In the high-power mode 1200, HPS2 is entered whenever it is detected that spare processing time is available in the communication component, during pen down. HPS2 may involve turning off at least the clock signal for the CPU core 1020 (FIG. 10), via the clock control module 1028.

In one specific embodiment, the communication component is adapted for Bluetooth™ communication and has a so-called sniff mode in which the communication component and the external terminal synchronously accesses a so-called piconet (which is set up between the pen and the terminal) at short regular intervals. Since coordinate data is generated at a frequency that reflects the frame rate of the image component, the communication component need only access the piconet at this frequency. Thus, in states HPS1 and HPS2, the communication component may be set in a sniff mode with a wake-up periodicity that is approximately proportional to the frame rate.

Generally, the medium-power mode 1202 is entered when the pen is removed from the paper for a short while. In one embodiment, the medium-power mode involves the image component being in its passive state and the communication component entering an MPS state, which is its third highest power state, in which all clocks except for the crystal oscillator (1032 in FIG. 10) may be turned off.

The communication component may still be in the above-mentioned sniff mode, possibly with a lower wake-up periodicity to further lower the power consumption. The selected wake-up periodicity will affect the response time experienced by the user. Thus, it is conceivable that the Pen sets the wake-up periodicity in dependence on the application program receiving the coordinate data on the terminal, e.g. as a function of a desired response time setting received from the application/terminal. In one embodiment, the communication component gradually decreases the wake-up periodicity as time progresses in the medium-power mode 1202. It should be realized that manipulating the wake-up periodicity for power management may be applicable to other communication protocols than Bluetooth.

Generally, the low-power mode 1204 is entered when the pen has been up for a long time. In one embodiment, the low-power mode 1204 is similar to the medium-power mode 1202, but with an even longer wake-up periodicity of the communication component. Alternatively, the communication component can enter an ULPS (ultra low power) state in which the crystal oscillator may be turned off.

It is also conceivable that the pen is caused to shut down completely after a predetermined timeout.

In order to change power mode two steps are present, step 1206 and step 1208.

Step 1206 involves, regardless of power mode, checking if the pen is active use or not, i.e. if pen down is detected or not. Such checking may be effected by repeatedly accessing the PDD signal of the PDD module, or by waiting for an event indicating a change in the PDD signal.

If the pen is detected to be in active use in step 1206, the electronic pen stays in or enters the high-power mode 1200.

However, if the pen is detected not to be in active use, e.g. the user has stopped writing (pen up), the pen will leave the high-power mode and enters step 1208 in which it is investigated whether the time t_{PM} during which the pen has been out of active use, is longer than a time limit t_{LIMIT}. If not, the pen will enter or stay in the medium-power mode 1202. It should thus be realized that the pen will enter the medium-power mode 1202 when the user lifts the pen between pen strokes. If the pen has been lifted (pen up) for a time period that exceeds the time limit, i.e. t_{PM}>t_{LIMIT}, the pen will enter the low-power mode 1204.

### Set-Up Procedure

Another aspect of the present invention is an improved method for setting up a communication link between an electronic pen and an external device, such as the external terminal 104, 802. The method may be implemented in any type of electronic pen. In the following, one embodiment of the set-up procedure will be described with reference to FIG. 13, in a pen with wireless communication to external devices, e.g. through the above-described communication component.

The set-up procedure is started (step 1300) by a dedicated trigger event, e.g. caused by a button on the pen being pressed, either the ON/OFF button 106 or a dedicated set-up button. Alternatively, the trigger event may be caused by the pen detecting a predetermined pattern, either directly from a captured image, from the extracted image data (dot list) or based on decoded coordinate data.

In step 1302, it is investigated if the pen has one or more pre-chosen external terminals. The pen may hold in its memory a list of such pre-chosen terminals, and/or the pre-chosen terminal can be the terminal to which the pen was last connected. In the example of Bluetooth communication, the list may indicate all terminals to which the pen is paired.

If the pen has no pre-chosen terminals, the pen enables selection of terminal (step 1304).

In one embodiment, this step involves the pen performing a scan for available terminals, i.e. terminals that are detectable to the communication component in the pen.

Thereafter, step 1306 involves investigating whether any such further terminals are available, and choosing one of these terminals, if possible. Step 1306 can also comprise receiving a confirmation signal from any discovered terminal, before connecting thereto (in step 1312). For example, a signal may be sent from the pen to the discovered terminal, whereby a dialog message may be shown on the terminal, prompting the user to accept the connection. If the user accepts connecting to the pen, a confirmation signal may be sent from the terminal to the pen.

In an alternative embodiment, step 1304 involves making the pen discoverable to terminals, e.g. by modifying a property of the communication component, and step 1306 involves receiving a confirmation signal from a terminal. For example, the confirmation signal may be generated in the terminal by the user choosing the pen from a list of discovered devices.

If a terminal is chosen, the pen attempts to connect to the chosen terminal (step 1312). In one embodiment, the chosen terminal is then added to the pen's list of pre-stored terminals, either when the terminal is chosen or when the pen has successfully connected to the chosen terminal.

If no terminal is chosen, the user may be alerted via a visual, tactile or audible indication issued by the pen (step 1308). Optionally, step 1308 may be divided in two steps; one for alerting the user that no external terminals were chosen and one for alerting the user of a connection failure (see below). Suitably, the alerts differ so that the user can distinguish one error from the other.

However, if it is found in step 1302 that the pen indeed has one or more pre-chosen external terminals, step 1310 is entered instead of step 1304.

In step 1310, it is investigated by way of the PDD module 1012/1156 whether the pen is applied onto the writing surface, or not.

If the electronic pen is applied onto the writing surface, step 1304 is entered. Thus, even if the pen has a pre-chosen external terminal, the user has the option to override the pen's connecting to such a terminal, to instead cause the pen to enable selection among other terminals. In an alternative embodiment, this option is available to the user also during step 1312, i.e. while the pen is still trying to connect to a pre-chosen terminal. To avoid inadvertent connections, step 1310 may require the user to hold the pen down onto the writing surface while also pressing the above-mentioned ON/OFF or set-up button, before entering step 1304. Alternatively or additionally, step 1310 may require the pen to be applied onto the writing surface for a predetermined period of time, before entering step 1304.

If the pen is not applied onto the writing surface, the pen attempts to connect to one of the pre-chosen external terminals (step 1312).

Thereafter, in step 1314, it is investigated whether the connection attempt succeeded or not. If the connection attempt failed, step 1308 is entered. Otherwise, if the connection attempt succeeded, step 1316 is entered in which coordinate data is transmitted from the pen to the terminal as described above.

The invention has mainly been described above with reference to a few embodiments. However, as is readily appreciated by a person skilled in the art, other embodiments than the ones disclosed above are equally possible within the scope of the invention, as defined by the appended patent claims.

1. An electronic pen for transmitting coordinate data to an external terminal, the pen being characterized by
an image component configured to generate a digital image of a region of a writing surface, and
a communication component comprising an image analysis module configured to receive image data representative of said digital image and to transform said image data into coordinate data, and a transmitter module configured to transmit said coordinate data to said external terminal.

2. The electronic pen of claim 1, wherein said communication component comprises a processor and a working memory, wherein said image analysis module is implemented by said processor executing image analysis software loaded into said working memory.

3. The electronic pen of claim 2, wherein said communication component is a standard communication circuit with spare processing capacity.

4. The electronic pen of claim 1, wherein said communication component is a Bluetooth™ communication circuit.

5. The electronic pen of claim 1, wherein software for controlling the operation of the pen is executed by a processor in the image component or the communication component.

6. The electronic pen of claim 1, further comprising a pre-processor module configured to extract said image data from said digital image.

7. The electronic pen of claim 6, wherein said pre-processor module is configured, when extracting said image data, to identify a pattern in said region.

8. The electronic pen of claim 7, wherein said image data is indicative of code symbols included in the pattern in said region.

9. The electronic pen of claim 7, wherein said pre-processor module is configured, when identifying said pattern, to find dots in said region.

10. The electronic pen of claim 9, wherein said pre-processor module is further configured to calculate center points of said dots in a reference system of said digital image.

11. The electronic pen of claim 10, wherein said image data comprises the locations of said center points in said reference system.

12. The electronic pen of claim 6, wherein said pre-processor module is part of said image component.

13. The electronic pen of claim 6, wherein said communication component is configured, when transforming said image data, to transform said image data into a predetermined perspective.

14. The electronic pen of claim 1, further comprising a pen-down detection module configured to discriminate between a pen-up state and a pen-down state.

15. The electronic pen of claim 14, further comprising a first power management module in said image component, and a second power management module in said communication component, each of said first power management module and second power management module being coupled to said pen-down detection module and being configured to control an operating mode of said image component and said communication component, respectively, based on a state indication from said pen-down detection module.

16. The electronic pen of claim 15, wherein each power management module's controlling of said operating mode involves selecting between different power modes of said image component and said communication component, respectively.

17. The electronic pen of claim 1, wherein said image analysis module is configured to transform said image data into coordinate data expressed in accordance with an established protocol for navigational input devices.

18. The electronic pen of claim 17, wherein said protocol for navigational input devices is HID (Human Interface Device).

19. The electronic pen of claim 1, wherein said digital image represents a coding pattern on said writing surface, said pen further comprising an access-granting module which is configured to receive an extracted property of the coding pattern in said digital image and, based upon the extracted property, output an access signal, wherein the operation of the image component and/or the communication component is conditioned upon said access signal to selectively block coordinate data from being transmitted from the pen.

20. The electronic pen of claim 1, wherein the communication component is configured to transmit said coordinate data in near real time as it is generated.

21. The electronic pen of claim 20, further comprising a buffer memory, wherein said communication component is configured to buffer the coordinate data in said buffer memory if unable to transmit the coordinate data to said external terminal.

22. A system for transmission of coordinate data, comprising:
an electronic pen for transmitting coordinate data to an external terminal, the pen including
an image component configured to generate a digital image of a region of a writing surface, and
a communication component comprising an image analysis module configured to receive image data representative of said digital image and to transform said image data into coordinate data, and a transmitter module configured to transmit said coordinate data to said external terminal; and
an external terminal configured for reception of coordinate data transmitted from said electronic pen.

23. A method for transmitting coordinate data from an electronic pen comprising an image component and a communication component to an external terminal, the method comprising:
generating, in said image component, a digital image representing a region of a writing surface,
receiving, in said communication component, image data representative of said digital image,
transforming the received image data into coordinate data in said communication component, and
transmitting said coordinate data from said communication component to said external terminal.

24. The method of claim 23, wherein said transforming is controlled by a processor of the communication component that executes image analysis software loaded into a working memory of the communication component.

25. The method of claim 22 further comprising extracting said image data from said digital image.

26. The method of claim 25, wherein said extracting comprises extracting features of code symbols included in a coding pattern in said region.

27. The method of claim 26, wherein said code symbols comprises dots that are displaced from grid points of a regular grid, and wherein said extracting comprises calculating center points of said dots in a reference system of said digital image.

28. The method of claim 25, wherein said extracting is performed in said image component.

29. A method for connecting an electronic pen to an external terminal, the method comprising:
initiating a set-up procedure for connecting the electronic pen to a pre-chosen external terminal; and
if a tip of said electronic pen is applied onto a surface during said set-up procedure, enabling selection among non-pre-chosen external terminals, and initiating a procedure for connecting to a selected terminal among said non-pre-chosen external terminals.

30. The method of claim 29, wherein said enabling comprises causing a communication device in the pen to scan for external terminals.

31. The method of claim 29, wherein said enabling comprises causing a communication device in the pen to be discoverable to external terminals.

32. An electronic pen, comprising:
electronic circuitry operable in a high-power mode, a medium-power mode and a low-power mode;
a sensor for detecting whether or not a tip of the electronic pen is in contact with a writing surface; and
a power management system coupled to the sensor and configured to operate the electronic circuitry:
in the high-power mode whenever the tip is in contact with the writing surface,
in the medium-power mode whenever the tip is brought out of contact with the writing surface, and
in the low-power mode when the tip has been out of contact with the writing surface for more than a predetermined time period.

33. The electronic pen of claim 32, wherein said electronic circuitry comprises at least one part of an image component configured to generate a digital image of a region on a writing surface, and at least one part of a communication component configured to receive image data representative of said digital image, transform said image data into coordinate data, and to transmit said coordinate data to an external terminal.

34. The electronic pen of claim 33, wherein said at least one part of the communication component, in the high-power mode, is caused to intermittently access a connection to the external terminal at a sniff rate corresponding to an image-generation rate of said at least one part of the image component.

35. The electronic pen of claim 34, wherein said at least one part of the communication component is caused to operate at a reduced sniff rate in the medium-power mode.

36. The electronic pen of claim 35, wherein the reduced sniff rate is at least partly set based on a setting received from the external terminal.

37. The electronic pen of claim 33, wherein said at least one part of the image component is powered down in the medium-power mode.
